(19) United States
(12) Patent Application Publication
(10) Pub. No.: US 2018/0115402 A1
(43) Pub. Date: Apr. 26, 2018

(54) TERMINAL DEVICE, BASE STATION DEVICE, INTEGRATED CIRCUIT, AND COMMUNICATION METHOD

(71) Applicant: Sharp Kabushiki Kaisha, Sakai City, Osaka (JP)

(72) Inventors: Hiroki TAKAHASHI, Sakai City (JP); Shoichi SUZUKI, Sakai City (JP); Tatsushi AIBA, Sakai City (JP); Kazunari YOKOMAKURA, Sakai City (JP)

(21) Appl. No.: 15/562,438

(22) PCT Filed: Mar. 4, 2016
(86) PCT No.: PCT/JP2016/056842

§ 371 Date: Sep. 28, 2017

(30) Foreign Application Priority Data
Apr. 9, 2015 (JP) 2015-079766

(51) Int. Cl. H04L 5/00; H04W 72/04; H04L 1/18; H04L 1/00

(52) U.S. Cl. CPC H04L 5/0055; H04W 72/0413; H04W 88/02; H04L 1/1861; H04L 1/0026; H04L 5/001

(57) ABSTRACT

A terminal device that communicates with a base station device is provided with: a transmission unit that uses one of multiple formats so as to transmit, through a physical uplink control channel, uplink control information including at least one of a HARQ-ACK, CSI, and a scheduling request (SR); and a higher layer processing unit that controls transmit power for transmission of the physical uplink control channel. The transmit power is based on a parameter calculated from a number of bits of the uplink control information to be transmitted. The parameter has a constant value for at least one of the multiple formats if the number of bits is greater than a prescribed value.

### TECHNICAL FIELD

The present invention relates to a terminal device, a base station device, an integrated circuit, and a communication method.

This application claims priority based on JP 2015-079766 filed on Apr. 9, 2015, the contents of which are incorporated herein by reference.

### BACKGROUND ART

In the 3rd Generation Partnership Project (3GPP), a radio access method and a radio network for cellular mobile communications (hereinafter referred to as “Long Term Evolution (LTE)”, or “Evolved Universal Terrestrial Radio Access (EUTRA)”) have been studied (NPL 1, NPL 2, NPL 3, NPL 4, and NPL 5). In LTE, a base station device is also referred to as an evolved NodeB (eNodeB), and a terminal device is also referred to as user equipment (UE). LTE is a cellular communication system in which an area is divided into multiple cells to form a cellular pattern, each of the cells being served by a base station device. Here, a single base station device may manage multiple cells.

LTE supports a time division duplex (TDD). LTE that employs a TDD scheme is also referred to as TD-LTE or LTE TDD. Uplink signals and downlink signals are time division multiplexed in TDD. LTE also supports a frequency division duplex (FDD).

In 3GPP, carrier aggregation has been specified which allows a terminal device to perform simultaneously transmission and/or reception in up to five serving cells (component carriers).

Further, in 3GPP, a configuration where a terminal device performs simultaneously transmission and/or reception in more than five serving cells (component carriers) has been considered (NPL 1). Furthermore, a configuration where a terminal device performs transmission on a physical uplink control channel in a secondary cell which is a serving cell other than a primary cell has been considered (NPL 6).

### CITATION LIST

### Non Patent Literature

NPL 1: “3GPP TS 36.211 V12.5.0 (2015-3) Evolved Universal Terrestrial Radio Access (E-UTRA); Physical channels and modulation (Release 12)”, 26th-Mar. 2015.

NPL 2: “3GPP TS 36.212 V12.4.0 (2015-3) Evolved Universal Terrestrial Radio Access (E-UTRA); Multiplexing and channel coding (Release 12)”, 26th-Mar. 2015.

NPL 3: “3GPP TS 36.213 V12.5.0 (2015-3) Evolved Universal Terrestrial Radio Access (E-UTRA); Physical layer procedures (Release 12)”, 26th-Mar. 2015.

NPL 4: “3GPP TS 36.321 V12.5.0 (2015-3) Evolved Universal Terrestrial Radio Access (E-UTRA); Medium Access Control (MAC) protocol specification (Release 12)”, 27th-Mar. 2015.

NPL 5: “3GPP TS 36.331 V12.5.0 (2015-3) Evolved Universal Terrestrial Radio Access (E-UTRA); Radio Resource Control (RRC); Protocol specification (Release 12)”, 27th-Mar. 2015.

NPL 6: “New WI proposal: LTE Carrier Aggregation Enhancement Beyond 5 Carriers”, RP-142286, Nokia Corporation, NTT DoCoMo Inc., Nokia Networks, 3GPP TSG RAN Meeting #66, Hawaii, United States of America, 8th-11 Dec. 2014.

### SUMMARY OF INVENTION

### Technical Problem

However, in the radio communication system as discussed above, a specific method for a process when transmitting uplink control information including Hybrid Automatic Repeat request ACKnowledgement (HARQ-ACK) corresponding to more than five downlink serving cells has not been sufficiently considered yet. In particular, because the known transmit power control of a terminal increases transmit power in proportion to the number of HARQ-ACK bits transmitted as uplink control information, there arises a problem that extremely high transmit power is configured in the terminal when a large number of HARQ-ACK bits are transmitted.

Some aspects of the present invention have been conceived in light of the foregoing, and an object of the present invention is to provide a terminal device, a base station device, an integrated circuit, and a communication method that are capable of efficient communication using multiple cells (component carriers).

### Solution to Problem

(1) In order to accomplish the object described above, an aspect of the present invention is contrived to provide the following means. That is, a terminal device according to an aspect of the present invention is a terminal device that communicates with a base station device and is provided with: a transmission unit configured to transmit, through a physical uplink control channel, uplink control information including at least one of a HARQ-ACK, CSI, and a scheduling request (SR) using one of multiple formats; and a higher layer processing unit configured to control transmit power for transmission of the physical uplink control channel. The transmit power is based on a parameter calculated from the number of bits of the uplink control information to be transmitted, and the parameter may have a constant value for at least one of the multiple formats in the case where the number of bits is greater than a prescribed value.

(2) The constant value in the terminal device may be a value configured by the base station device via a higher layer.

(3) A base station device according to an aspect of the present invention is a base station device that communicates with a terminal device and is provided with: a reception unit configured to receive, from the terminal device through a physical uplink control channel, uplink control information including at least one of a HARQ-ACK, CSI, and a scheduling request (SR) using one of multiple formats; a higher layer processing unit configured to determine a first parameter to control transmit power of the terminal device for transmission of the physical uplink control channel; and a transmission unit configured to transmit the first parameter to the terminal device. The higher layer processing unit determines the first parameter while taking into consideration that the terminal device determines the transmit power based on a second parameter calculated from the number of bits of the uplink control information to be transmitted, and the second parameter may have a constant value for at least one of the multiple formats in the case where the number of bits is greater than a prescribed value.

(4) The base station device may transmit the constant value to the terminal device via a higher layer.

(5) An integrated circuit according to an aspect of the present invention is an integrated circuit that is mounted in a terminal device communicating with a base station device and causes the terminal device to exhibit a series of functions including: a function to transmit, through a physical uplink control channel, uplink control information including at least one of a HARQ-ACK, CSI, and a scheduling request (SR) using one of multiple formats; and a function to control transmit power for transmission of the physical uplink control channel. The transmit power is based on a parameter calculated from the number of bits of the uplink control information to be transmitted, and the parameter may have a constant value for at least one of the multiple formats in the case where the number of bits is greater than a prescribed value.

(6) The constant value in the integrated circuit may be a value configured by the base station device via a higher layer.

(7) An integrated circuit according to an aspect of the present invention is an integrated circuit that is mounted in a base station device communicating with a terminal device and may cause the base station device to exhibit a series of functions including: a function to receive, from the terminal device through a physical uplink control channel, uplink control information including at least one of a HARQ-ACK, CSI, and a scheduling request (SR) using one of multiple formats; a function to determine a first parameter to control transmit power of the terminal device for transmission of the physical uplink control channel; and a function to transmit the first parameter to the terminal device. The first parameter is determined while taking into consideration that the terminal device determines the transmit power based on a second parameter calculated from the number of bits of the uplink control information to be transmitted, and the second parameter may have a constant value for at least one of the multiple formats in the case where the number of bits is greater than a prescribed value.

(8) The integrated circuit may cause the base station device to exhibit a function to transmit the constant value to the terminal device via a higher layer.

(9) A communication method according to an aspect of the present invention is a communication method that is used in a terminal device communicating with a base station device and includes the steps of: transmitting, through a physical uplink control channel, uplink control information including at least one of a HARQ-ACK, CSI, and a scheduling request (SR) using one of multiple formats; and controlling transmit power for transmission of the physical uplink control channel. The transmit power is based on a parameter calculated from the number of bits of the uplink control information to be transmitted, and the parameter may have a constant value for at least one of the multiple formats in the case where the number of bits is greater than a prescribed value.

(10) The constant value in the communication method may be a value configured by the base station device via a higher layer.

(11) A communication method according to an aspect of the present invention is a communication method that is used in a base station device communicating with a terminal device and includes the steps of: receiving, from the terminal device through a physical uplink control channel, uplink control information including at least one of a HARQ-ACK, CSI, and a scheduling request (SR) using one of multiple formats; determining a first parameter to control transmit power of the terminal device for transmission of the physical uplink control channel; and transmitting the first parameter to the terminal device. The first parameter is determined while taking into consideration that the terminal device determines the transmit power based on a second parameter calculated from the number of bits of the uplink control information to be transmitted, and the second parameter may have a constant value for at least one of the multiple formats in the case where the number of bits is greater than a prescribed value.

(12) The communication method may transmit the constant value to the terminal device via a higher layer.

### Advantageous Effects of Invention

According to some aspects of the present invention, uplink control information can be transmitted efficiently.

### BRIEF DESCRIPTION OF DRAWINGS

FIG. 1 is a conceptual diagram of a radio communication system according to the present embodiment.

FIG. 2 is a diagram illustrating a schematic configuration of a radio frame according to the present embodiment.

FIG. 3 is a diagram illustrating a configuration of a slot according to the present embodiment.

FIG. 4 is a diagram illustrating one example of allocation of a physical channel and mapping of a physical signal to a downlink subframe according to the present embodiment.

FIG. 5 is a diagram illustrating one example of allocation of a physical channel and mapping of a physical signal to an uplink subframe according to the present embodiment.

FIG. 6 is a diagram illustrating one example of allocation of a physical channel and mapping of a physical signal to a special subframe according to the present embodiment.

FIGS. 7A to 7C are diagrams describing a PUCCH cell group according to the present embodiment.

FIG. 8 is a table showing one example of a UL-DL configuration according to the present embodiment.

FIG. 9 is a schematic block diagram illustrating a configuration of a terminal device 1 according to the present embodiment.

FIG. 10 is a schematic block diagram illustrating a configuration of a base station device 3 according to the present embodiment.

### DESCRIPTION OF EMBODIMENTS

Some embodiments of the present invention will be described below.

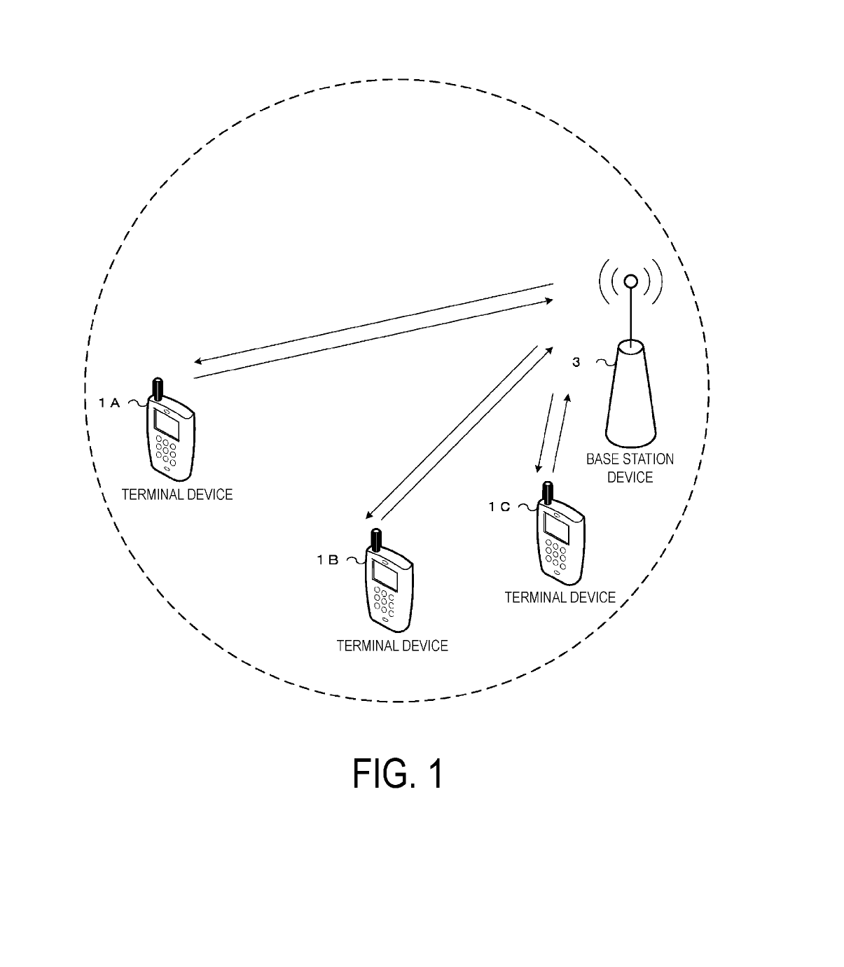

FIG. 1 is a conceptual diagram of a radio communication system according to the present embodiment. In FIG. 1, the radio communication system includes terminal devices 1A to 1C and a base station device 3. The terminal devices 1A to 1C are each also referred to as a terminal device 1 below.

Physical channels and physical signals according to the present embodiment will be described.

In FIG. 1, uplink radio communication from the terminal device 1 to the base station device 3 uses the following uplink physical channels. The uplink physical channels are used to transmit information output from a higher layer.
Physical uplink control channel (PUCCH)
Physical uplink shared channel (PUSCH)
Physical random access channel (PRACH)

The PUCCH is used to transmit uplink control information (UCI). Here, the uplink control information may include channel state information (CSI) used to indicate a state of a downlink channel. Further, the uplink control information may include a scheduling request (SR) used to request a UL-SCH resource. Furthermore, the uplink control information may include a Hybrid Automatic Repeat request ACKnowledgement (HARQ-ACK). The stated HARQ-ACK indicates a HARQ-ACK with respect to downlink data (transport block, medium access control protocol data unit (MAC PDU), downlink-shared channel (DL-SCH), and physical downlink shared channel (PDSCH)).

In other words, the HARQ-ACK indicates an acknowledgement (ACK) or a negative-acknowledgement (NACK). The HARQ-ACK is also referred to as ACK/NACK, HARQ feedback, HARQ acknowledge, HARQ information, or HARQ control information.

The PUSCH is used to transmit uplink data (uplink-shared channel (UL-SCH)). Furthermore, the PUSCH may be used to transmit the HARQ-ACK and/or channel state information along with the uplink data. Moreover, the PUSCH may be used to transmit only the channel state information or to transmit only the HARQ-ACK and the channel state information. That is to say, the PUSCH may be used to transmit only the uplink control information.

The base station device 3 and the terminal device 1 exchange (transmit/receive) a signal in a higher layer. For example, in a radio resource control (RRC) layer, the base station device 3 and the terminal device 1 may transmit/receive RRC signaling (also called a radio resource control message (RRC message) or radio resource control information (RRC information)). Further, the base station device 3 and the terminal device 1 may transmit/receive, in a medium access control (MAC) layer, MAC control elements. Here, the RRC signaling and/or the MAC control element is also referred to as higher layer signaling.

The PUSCH is used to transmit the RRC signaling and the MAC control element. The RRC signaling transmitted from the base station device 3 may be common signaling to multiple terminal devices 1 within a cell. The RRC signaling transmitted from the base station device 3 may be such signaling that is dedicated to a certain terminal device 1 (also called dedicated signaling). In other words, user device-specific information is transmitted to the above-mentioned certain terminal device 1 using the dedicated signaling.

The PRACH is used to transmit a random access preamble. The PRACH is used for the initial connection establishment procedure, the handover procedure, the connection re-establishment procedure, synchronization (timing adjustment) for uplink transmission, and the request for the PUSCH resource.

In FIG. 1, the following uplink physical signal is used in the uplink radio communication. The uplink physical signal is not used to transmit information output from the higher layer, but is used by a physical layer.
Uplink reference signal (UL RS)

According to the present embodiment, the following two types of uplink reference signals are used.
Demodulation reference signal (DMRS)
Sounding reference signal (SRS)

The DMRS relates to transmission of the PUSCH or the PUCCH. The DMRS is time-multiplexed with the PUSCH or the PUCCH. The base station device 3 uses the DMRS in order to perform channel compensation of the PUSCH or the PUCCH. Transmission of both of the PUSCH and the DMRS is hereinafter referred to simply as transmission of the PUSCH. Transmission of both of the PUCCH and the DMRS is hereinafter referred to simply as transmission of the PUCCH.

The SRS is not associated with the transmission of the PUSCH or the PUCCH. The base station device 3 uses the SRS in order to measure an uplink channel state.

In FIG. 1, the following downlink physical channels are used for downlink radio communication from the base station device 3 to the terminal device 1. The downlink physical channels are used to transmit the information output from the higher layer.
Physical broadcast channel (PBCH)
Physical control format indicator channel (PCFICH)
Physical hybrid automatic repeat request indicator channel (PHICH)
Physical downlink control channel (PDCCH)
Enhanced physical downlink control channel (EPDCCH)
Physical downlink shared channel (PDSCH)
Physical multicast channel (PMCH)

The PBCH is used to broadcast a master information block (MIB), or a broadcast channel (BCH), that is shared by the terminal devices 1.

The PCFICH is used to transmit information indicating a region (OFDM symbols) to be used for transmission of the PDCCH.

The PHICH is used to transmit an HARQ indicator (HARQ feedback or response information) indicating an acknowledgement (ACK) or a negative acknowledgement (NACK) with respect to the uplink data (uplink shared channel (UL-SCH)) received by the base station device 3.

The PDCCH and the EPDCCH are used to transmit downlink control information (DCI).

The PDSCH is used to transmit downlink data (downlink shared channel (DL-SCH)). In addition, the PDSCH is used to transmit a system information message. The system information message may be cell-specific information. The system information is included in the RRC signaling. The PDSCH is used to transmit the RRC signaling and the MAC control element.

The PMCH is used to transmit multicast data (multicast channel (MCH)).

In FIG. 1, the following downlink physical signals are used in the downlink radio communication. The downlink physical signals are not used to transmit the information output from the higher layer, but are used by the physical layer.
Synchronization signal (SS)
Downlink reference signal (DL RS)

The synchronization signal is used in order for the terminal device 1 to be synchronized in terms of frequency and time domains for downlink. In the TDD scheme, the synchronization signal is mapped to subframes 0, 1, 5, and 6 within a radio frame. In the FDD scheme, the synchronization signal is mapped to subframes 0 and 5 within the radio frame.

The downlink reference signal is used in order for the terminal device 1 to perform the channel compensation on the downlink physical channel. The downlink reference signal is used in order for the terminal device 1 to calculate the downlink channel state information.

According to the present embodiment, the following five types of downlink reference signals are used.
Cell-specific reference signal (CRS)
UE-specific reference signal (URS) associated with the PDSCH
Demodulation reference signal (DMRS) associated with the EPDCCH
Non-zero power channel state information-reference signal (NZP CSI-RS)
Zero power channel state information-reference signal (ZP CSI-RS)
Multimedia broadcast and multicast service over single frequency network reference signal (MBSFN RS)
Positioning reference signal (PRS)

The downlink physical channels and the downlink physical signals are collectively referred to as a downlink signal. The uplink physical channels and the uplink physical signals are collectively referred to as an uplink signal. The downlink physical channels and the uplink physical channels are collectively referred to as a physical channel. The downlink physical signals and the uplink physical signals are collectively referred to as a physical signal.

The BCH, the MCH, the UL-SCH, and the DL-SCH are transport channels. A channel used in a medium access control (MAC) layer is referred to as a transport channel. The unit of the transport channel used in the MAC layer is also referred to as a transport block (TB) or a MAC protocol data unit (PDU). Control of a hybrid automatic repeat request (HARM) is performed on each transport block in the MAC layer. The transport block is a unit of data that the MAC layer delivers to the physical layer. In the physical layer, the transport block is mapped to a codeword, and coding processing is performed on a codeword-by-codeword basis.

Carrier aggregation will be described below.

In FIG. 1, one or multiple serving cells may be configured for the terminal device 1. A technique in which the terminal device 1 communicates via multiple serving cells is referred to as cell aggregation or carrier aggregation. The present invention may be applied to each of one or multiple serving cells configured for the terminal device 1. The present invention may be applied to some of one or multiple serving cells configured for the terminal device 1. The present invention may be applied to each of groups of one or multiple serving cells configured for the terminal device 1, which will be explained later. Furthermore, the present invention may be applied to some of the groups of one or multiple serving cells configured for the terminal device 1.

Time division duplex (TDD) and/or frequency division duplex (FDD) may be applied to the radio communication system illustrated in FIG. 1. In the case of carrier aggregation, TDD or FDD may be applied to all of one or multiple serving cells. Alternatively, in the case of carrier aggregation, serving cells to which TDD is applied and serving cells to which FDD is applied may be aggregated.

The frame structure corresponding to FDD is also called a frame structure type 1.
The frame structure corresponding to TDD is also called a frame structure type 2.

Here, one or multiple serving cells being configured include one primary cell and one or multiple secondary cells. The primary cell may be a serving cell in which an initial connection establishment procedure has been performed, a serving cell in which a connection re-establishment procedure has been started, or a cell indicated as a primary cell during a handover procedure. At a point in time when a radio resource control (RRC) connection is established, or later, a secondary cell may be configured.

A carrier corresponding to a serving cell in the downlink is referred to as a downlink component carrier. A carrier corresponding to a serving cell in the uplink is referred to as an uplink component carrier. Further, the downlink component carrier and the uplink component carrier are collectively referred to as a component carrier.

The terminal device 1 can perform simultaneously transmission and/or reception on multiple physical channels in one or multiple serving cells (component carriers). One single physical channel is transmitted in one serving cell (component carrier) of the multiple serving cells (component carriers).

The primary cell is used for transmission of the PUCCH. Further, the primary cell cannot be deactivated. Cross carrier scheduling does not apply to the primary cell. In other words, the primary cell is always scheduled via its PDCCH. In a case that (monitoring) the PDCCH of a certain secondary cell is configured, the cross carrier scheduling may not apply to this secondary cell. That is, in this case, the stated secondary cell may always be scheduled via its PDCCH. Further, in a case that (monitoring) the PDCCH of a certain secondary cell is not configured, the cross carrier scheduling may be applied and the stated secondary cell may always be scheduled via the PDCCH of one other serving cell.

Here, in the present embodiment, a secondary cell used for transmission of a PUCCH is referred to as a PUCCH secondary cell or a special secondary cell. Further, in the present embodiment, a secondary cell not used for the transmission of the PUCCH is referred to as a non-PUCCH secondary cell, a non-special secondary cell, a non-PUCCH serving cell, or a non-PUCCH cell. The primary cell and the PUCCH secondary cell are collectively referred to as a PUCCH serving cell or a PUCCH cell.

The PUCCH serving cell (the primary cell, the PUCCH secondary cell) always includes the downlink component carrier and the uplink component carrier. A resource for the PUCCH is configured in the PUCCH serving cell (the primary cell, the PUCCH secondary cell).

The non-PUCCH serving cell (non-PUCCH secondary cell) may include only the downlink component carrier. Further, the non-PUCCH serving cell (non-PUCCH secondary cell) may include the downlink component carrier and the uplink component carrier.

The terminal device 1 performs transmission on the PUCCH in the PUCCH serving cell. In other words, the terminal device 1 performs transmission on the PUCCH in the primary cell. Further, the terminal device 1 performs transmission on the PUCCH in the PUCCH secondary cell. The terminal device 1 does not perform transmission on the PUCCH in the non-special secondary cell.

Note that the PUCCH secondary cell may be defined as a serving cell other than the primary cell or the secondary cell.

That is, the PUCCH secondary cell is used for transmission of the PUCCH. Further, the PUCCH secondary cell may not be deactivated. Here, as will be explained later, the PUCCH secondary cell may be activated and/or deactivated.

Note that the cross carrier scheduling may not apply to the PUCCH secondary cell. In other words, the PUCCH secondary cell may always be scheduled via its PDCCH. Note that the cross carrier scheduling may apply to the PUCCH secondary cell. That is, the PUCCH secondary cell may be scheduled via the PDCCH of one other serving cell.

For example, in a case that (monitoring) the PDCCH of a PUCCH secondary cell is configured, the cross carrier scheduling may not apply to this PUCCH secondary cell. That is, in this case, the stated PUCCH secondary cell may always be scheduled via its PDCCH. Further, in a case that (monitoring) the PDCCH of the PUCCH secondary cell is not configured, the cross carrier scheduling may be applied and the stated PUCCH secondary cell may always be scheduled via the PDCCH of one other serving cell.

Here, linking may be defined between the uplink (for example, the uplink component carrier) and the downlink (for example, the downlink component carrier). That is, based on the linking between the uplink and the downlink, a serving cell for downlink assignment (a serving cell in which transmission on the PDSCH scheduled by the downlink assignment (downlink transmission) is performed) may be identified. Further, based on the linking between the uplink and the downlink, a serving cell for uplink grant (a serving cell in which transmission on the PUSCH scheduled by the uplink grant (uplink transmission) is performed) may be identified. Note that a carrier indicator field is not present in the downlink assignment or the uplink.

That is, the downlink assignment received in the primary cell corresponds to the transmission of the downlink in the primary cell. The uplink grant received in the primary cell corresponds to the transmission of the uplink in the primary cell. Further, the downlink assignment received in the PUCCH secondary cell may correspond to the transmission of the downlink in the PUCCH secondary cell.

The uplink grant received in the PUCCH secondary cell may correspond to the transmission of the uplink in the PUCCH secondary cell. Further, the downlink assignment received in a certain secondary cell (a PUCCH secondary cell and/or a non-PUCCH secondary cell) may correspond to the transmission of the downlink in the stated certain secondary cell. Further, the uplink grant received in a certain secondary cell (a PUCCH secondary cell and/or a non-PUCCH secondary cell) may correspond to the transmission of the uplink in the stated certain secondary cell.

A configuration of the radio frame according to the present embodiment will be described below.

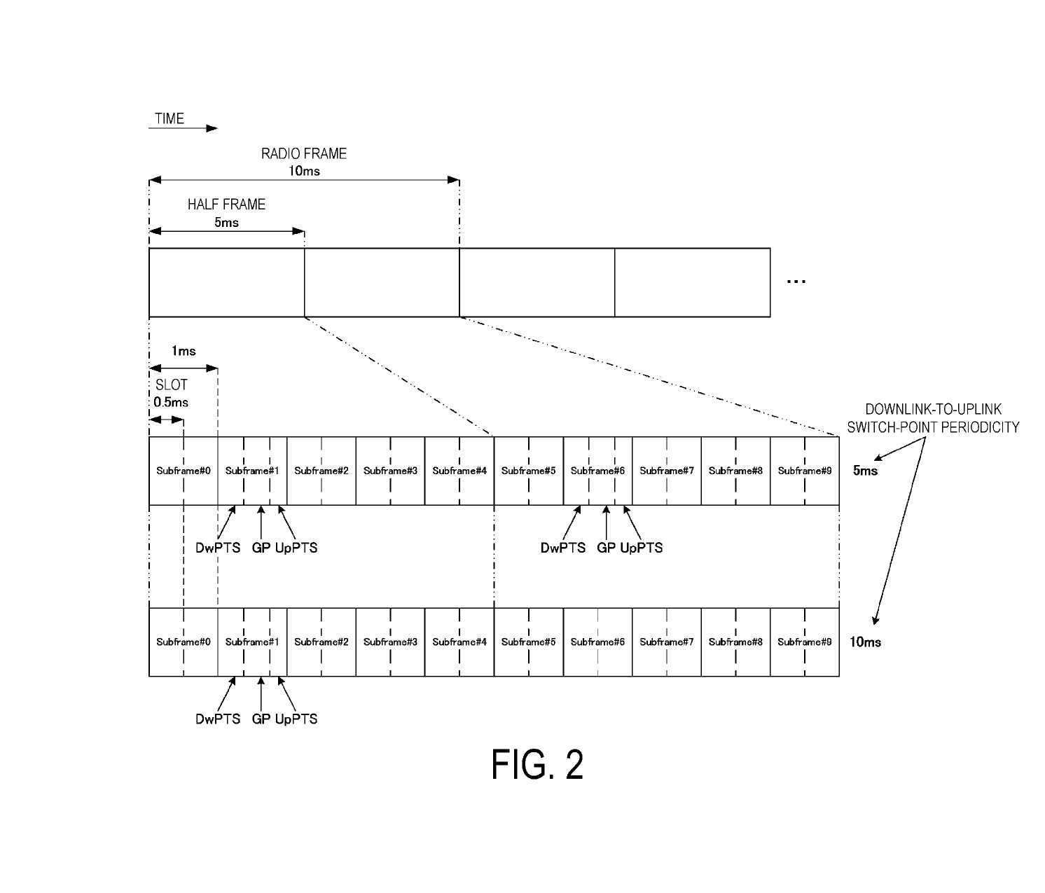

FIG. 2 is a diagram illustrating a schematic configuration of the radio frame according to the present embodiment. Each of the radio frames is 10 ms in length. In FIG. 2, the horizontal axis is a time axis. Furthermore, each of the radio frames is constituted of two half frames. Each of the half frames is 5 ms in length. Each of the half frames is constituted of five subframes. Each of the subframes is 1 ms in length and is defined by two consecutive slots. Each of the slots is 0.5 ms in length. The i-th subframe within a radio frame is constituted of the (2×i)-th slot and the (2×i+1)-th slot. To be more precise, 10 subframes are available in each 10 ms interval.

According to the present embodiment, the following three types of subframes are defined.
Downlink subframe (a first subframe)
Uplink subframe (a second subframe)
Special subframe (a third subframe)

The downlink subframe is a subframe reserved for downlink transmission. The uplink subframe is a subframe reserved for uplink transmission. The special subframe is constituted of three fields. The three fields are a downlink pilot time slot (DwPTS), a guard period (GP), and an uplink pilot time slot (UpPTS). The sum of lengths of the DwPTS, the GP, and the UpPTS within one special subframe is 1 ms. The DwPTS is a field reserved for the downlink transmission. The UpPTS is a field reserved for the uplink transmission. The GP is a field in which neither the downlink transmission nor the uplink transmission is performed. Moreover, the special subframe may be constituted only of the DwPTS and the GP, or may be constituted only of the GP and the UpPTS.

A single radio frame is constituted of at least a downlink subframe, an uplink subframe, and a special subframe.

A configuration of the slot according to the present embodiment will be described below.

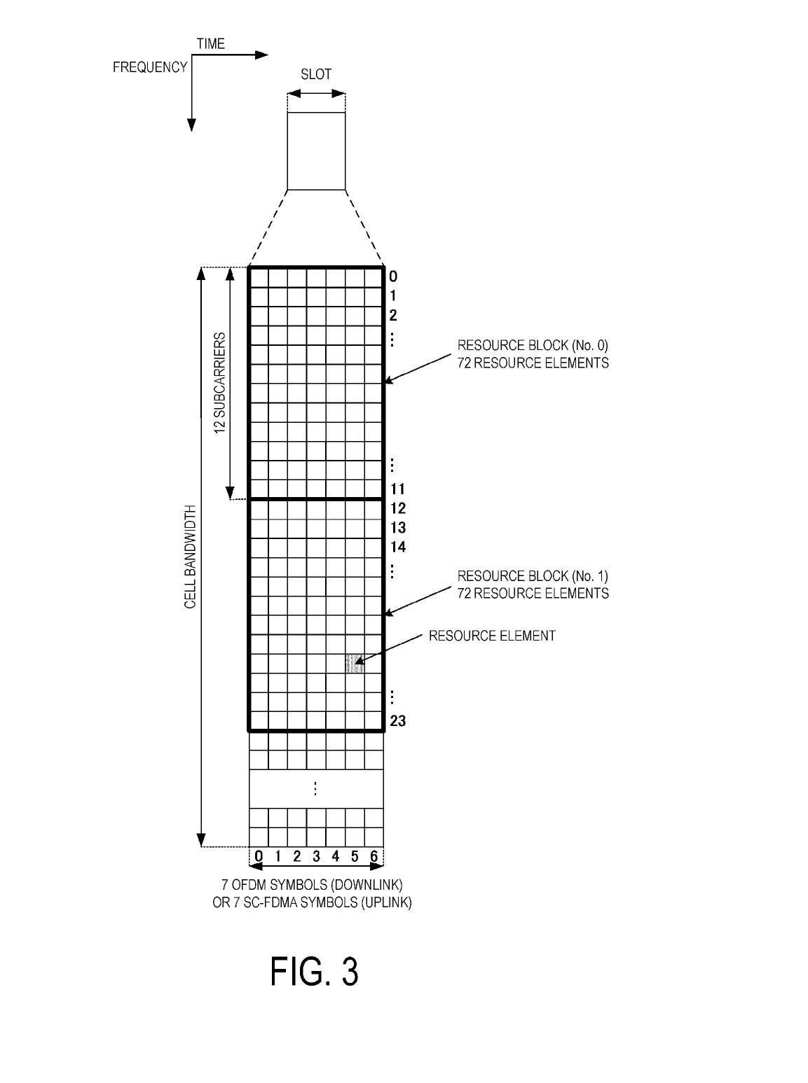

FIG. 3 is a diagram illustrating the configuration of the slot according to the present embodiment. According to the present embodiment, a normal cyclic prefix (CP) may be applied to an OFDM symbol. Moreover, an extended cyclic prefix (CP) may be applied to the OFDM symbol. The physical signal or the physical channel transmitted in each of the slots is expressed by a resource grid. In FIG. 3, the horizontal axis is a time axis, and the vertical axis is a frequency axis.

In the downlink, the resource grid may be defined by multiple subcarriers and multiple OFDM symbols. In the uplink, the resource grid may be defined by multiple subcarriers and multiple SC-FDMA symbols. The number of subcarriers constituting one slot may depend on a cell bandwidth. The number of OFDM symbols or SC-FDMA symbols constituting one slot may be seven. Each element within the resource grid is referred to as a resource element. The resource element may be identified by a subcarrier number, and an OFDM symbol or SC-FDMA symbol number.

A resource block may be used to express mapping of a certain physical channel (the PDSCH, the PUSCH, or the like) to resource elements. For the resource block, a virtual resource block and a physical resource block may be defined. A certain physical channel may be first mapped to the virtual resource block. Thereafter, the virtual resource block may be mapped to the physical resource block. One physical resource block may be defined by seven consecutive OFDM symbols or SC-FDMA symbols in a time domain and by 12 consecutive subcarriers in a frequency domain. Therefore, one physical resource block may be constituted of (7×12) resource elements. Furthermore, one physical resource block may correspond to one slot in the time domain and may correspond to 180 kHz in the frequency domain. Physical resource blocks may be numbered from 0 in the frequency domain.

The physical channel and the physical signal that are transmitted in each of the subframes will be described below.

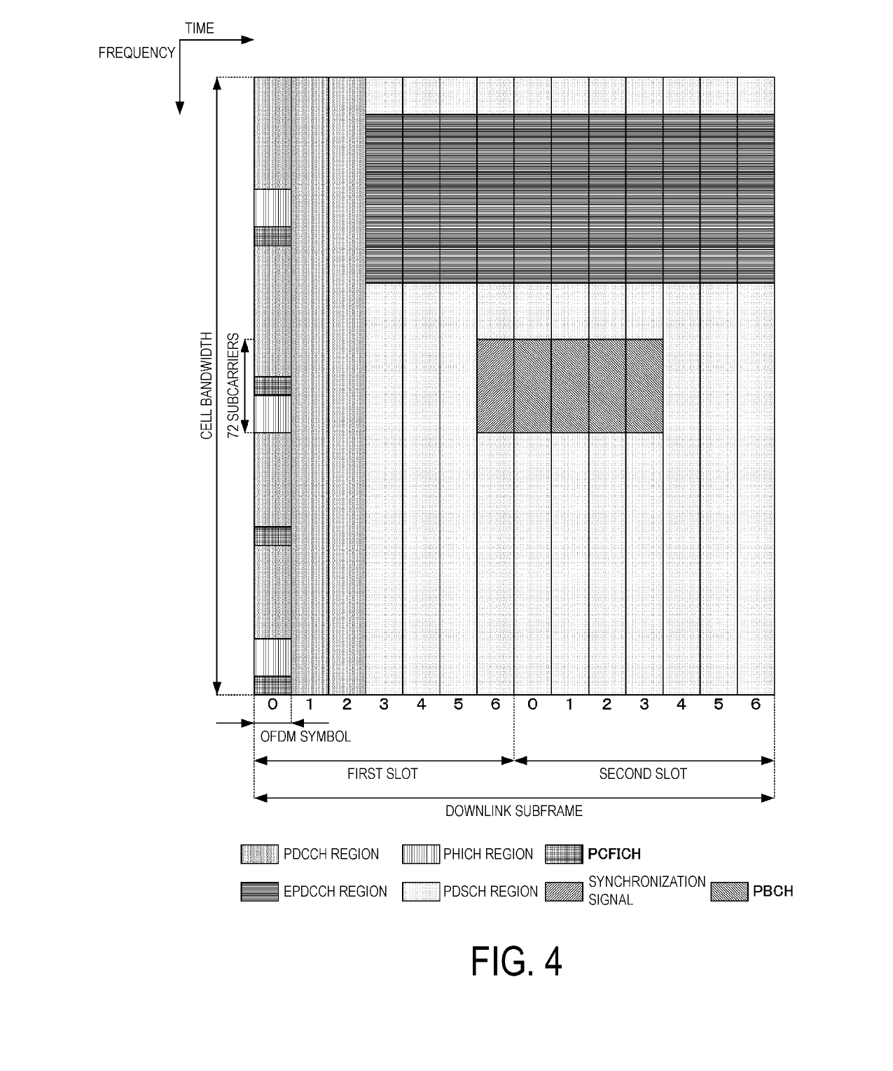

FIG. 4 is a diagram illustrating one example of allocation of the physical channel and mapping of the physical signal to the downlink subframe according to the present embodiment. In FIG. 4, the horizontal axis is a time axis, and the vertical axis is a frequency axis. In the downlink subframe, the base station device 3 may transmit the downlink physical channel (the PBCH, the PCFICH, the PHICH, the PDCCH, the EPDCCH, or the PDSCH), and the downlink physical signal (the synchronization signal or the downlink reference signal). Moreover, the PBCH is transmitted only in subframe 0 within the radio frame. Moreover, the downlink reference signal is mapped to the resource elements distributed in the frequency domain and the time domain. The downlink reference signal is not illustrated in FIG. 4 for the sake of simplicity.

Multiple PDCCHs may be frequency-multiplexed and time-multiplexed in a PDCCH region. Multiple EPDCCHs may be frequency-multiplexed, time-multiplexed, and spatial-multiplexed in an EPDCCH region. Multiple PDSCHs may be frequency-multiplexed and spatial-multiplexed in a PDSCH region. The PDCCH, and the PDSCH or the EPDCCH may be time-multiplexed. The PDSCH and the EPDCCH may be frequency-multiplexed.

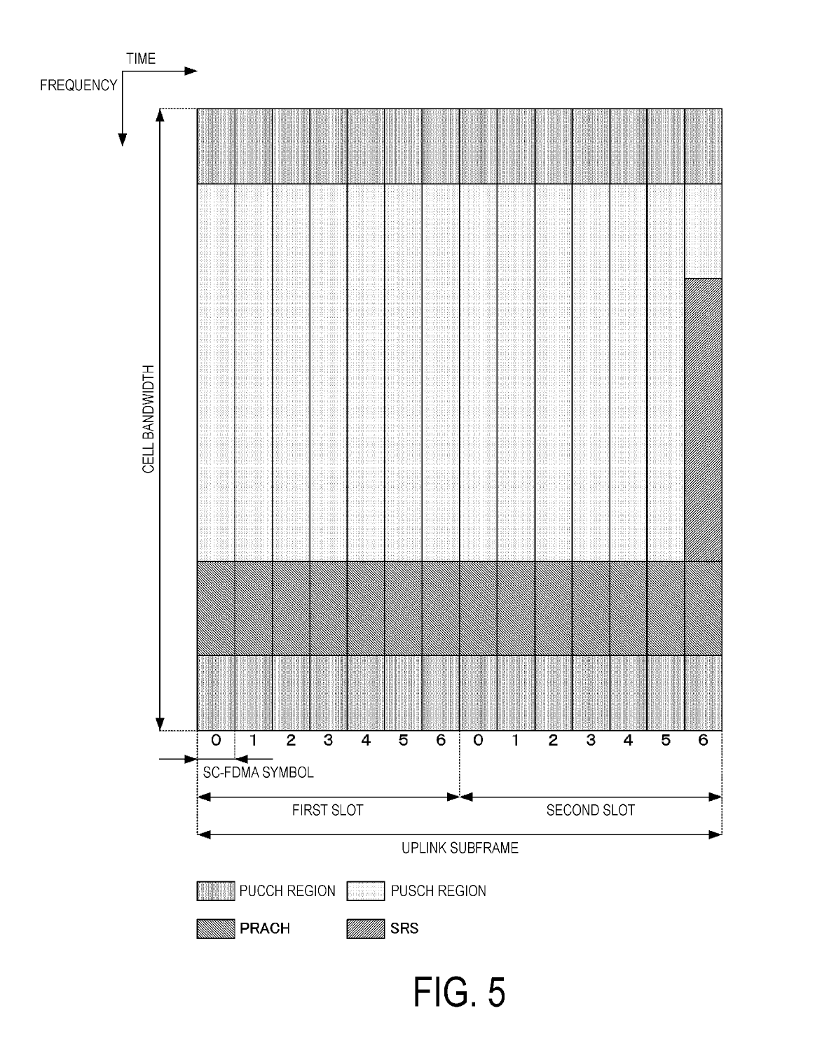

FIG. 5 is a diagram illustrating one example of the allocation of the physical channel and the mapping of the physical signal to the uplink subframe according to the present embodiment. In FIG. 5, the horizontal axis is a time axis, and the vertical axis is a frequency axis. In the uplink subframe, the terminal device 1 may transmit the uplink physical channel (the PUCCH, the PUSCH or the PRACH) and the uplink physical signal (the DMRS or the SRS). In a PUCCH region, multiple PUCCHs are frequency-multiplexed, time-multiplexed, and code-multiplexed. Multiple PUSCHs may be frequency-multiplexed and spatial-multiplexed in a PUSCH region. The PUCCH and the PUSCH may be frequency-multiplexed. The PRACH may be allocated to a single subframe or over two subframes. Furthermore, multiple PRACHs may be code-multiplexed.

The SRS is transmitted using the last SC-FDMA symbol within the uplink subframe. To be more precise, the SRS is mapped to the last SC-FDMA symbol within the uplink subframe. The terminal device 1 cannot transmit the SRS and the PUCCH/PUSCH/PRACH at the same time in a single SC-FDMA symbol in a single cell. In a single uplink subframe in a single cell, the terminal device 1 can transmit the PUSCH and/or the PUCCH using the SC-FDMA symbol except for the last SC-FDMA symbol within the uplink subframe, and can transmit the SRS using the last SC-FDMA symbol within the uplink subframe. To be more precise, in a single uplink subframe in a single cell, the terminal device 1 can transmit both of the SRS and the PUSCH/PUCCH. Moreover, the DMRS is time-multiplexed with the PUCCH or the PUSCH. The DMRS is not illustrated in FIG. 5 for the sake of simplicity.

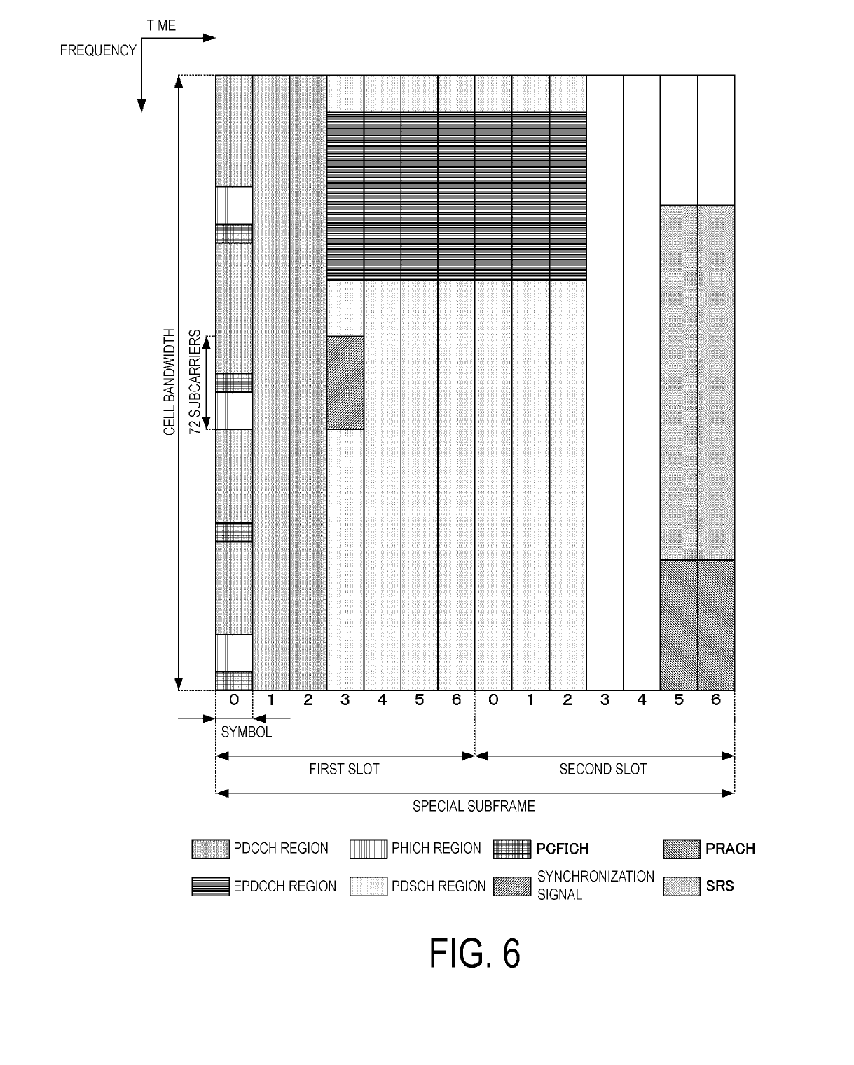

FIG. 6 is a diagram illustrating one example of allocation of the physical channel and mapping of the physical signal to the special subframe according to the present embodiment. In FIG. 6, the horizontal axis is a time axis, and the vertical axis is a frequency axis. In FIG. 6, the DwPTS is constituted of first to 10-th SC-FDMA symbols within the special subframe, the GP is constituted of 11-th and 12-th SC-FDMA symbols within the special subframe, and the UpPTS is constituted of 13-th and 14-th SC-FDMA symbols within the special subframe.

The base station device 3 may transmit the PCFICH, the PHICH, the PDCCH, the EPDCCH, the PDSCH, the synchronization signal, and the downlink reference signal, in the DwPTS of the special subframe. The base station device 3 does not transmit the PBCH in the DwPTS of the special subframe. The terminal device 1 may transmit the PRACH and the SRS in the UpPTS of the special subframe. To be more precise, the terminal device 1 transmits none of the PUCCH, the PUSCH, and the DMRS in the UpPTS of the special subframe.

In the present embodiment, a group of the multiple serving cells is referred to as a PUCCH cell group. A certain serving cell belongs to any one of PUCCH cell groups.

A single PUCCH cell group includes one PUCCH serving cell. A single PUCCH cell group may include only one PUCCH serving cell. A single PUCCH cell group may include one PUCCH serving cell and one or multiple non-PUCCH serving cells.

The PUCCH cell group including the primary cell is referred to as a primary PUCCH cell group. The PUCCH cell group not including the primary cell is referred to as a secondary PUCCH cell group. In other words, the secondary PUCCH cell group includes a PUCCH secondary cell. For example, an index for the primary PUCCH cell group may always be defined to be 0. An index for the secondary PUCCH cell group may be configured by the base station device 3 (or may be configured by a network device).

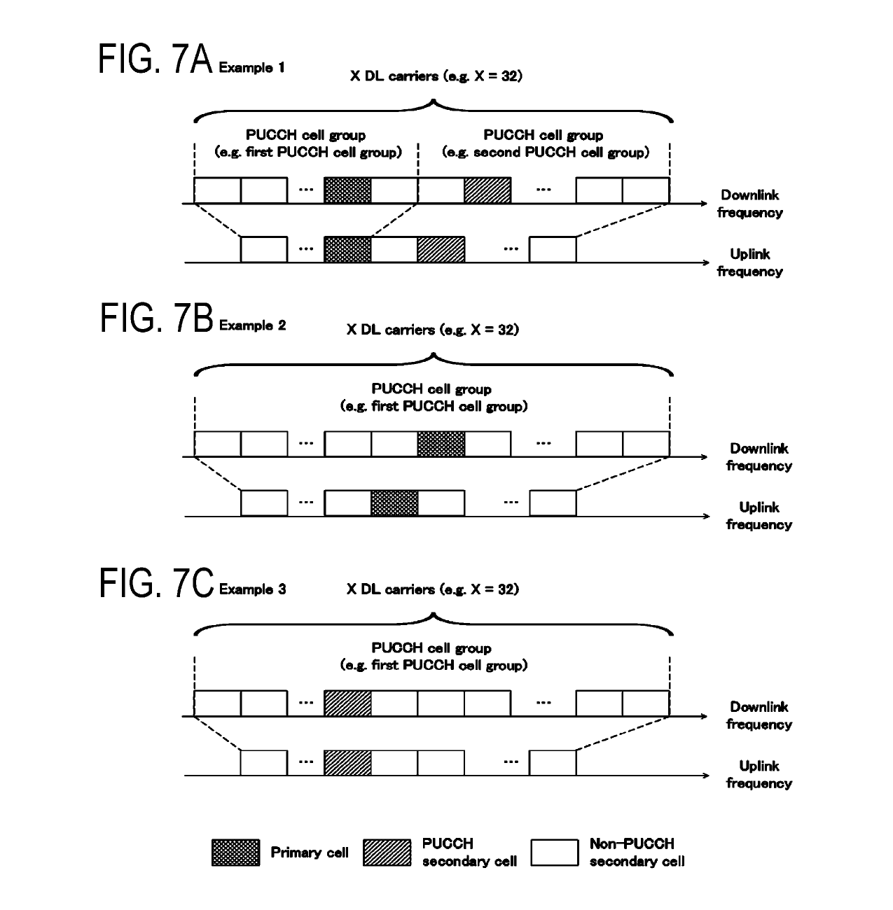

FIGS. 7A to 7C are diagrams describing a PUCCH cell group according to the present embodiment.

In the present embodiment, for example, the career aggregation of up to 32 downlink component carriers (downlink cells) may be supported as illustrated in the drawings. In other words, the base station device 3 and the terminal device 1 can perform simultaneous transmission and/or reception on multiple physical channels in up to 32 serving cells. Here, the number of the uplink component carriers may be less than the number of the downlink component carriers.

For example, the base station device 3 may configure a cell group associated with the transmission on the PUCCH (hereinafter also called a PUCCH cell group). For example, a PUCCH cell group may be associated with the transmission of the uplink control information on the PUCCH. FIG. 3 illustrates three examples (Example (a), Example (b), Example (c)) as examples of the configuration (constitution, definition) of a PUCCH cell group. It goes without saying that a PUCCH cell group may be configured differently from the examples illustrated in FIGS. 7A to 7C.

For example, the base station device 3 may transmit the higher layer signaling including information to be used for configuring a PUCCH cell group. For example, an index (a cell group index, information) to identify a PUCCH cell group may be configured (defined), and the base station device 3 may transmit the higher layer signaling including the index to be used for identifying the PUCCH cell group.

FIG. 7A illustrates that a first PUCCH cell group and a second PUCCH cell group are configured as a PUCCH cell group. For example, in FIG. 7A, the base station device 3 may transmit a downlink signal in the first PUCCH cell group, and the terminal device 3 may transmit an uplink signal in the first PUCCH cell group (may transmit uplink control information on the PUCCH of the first PUCCH cell group). For example, in the case where 20 serving cells (downlink component carriers or downlink cells may also be possible) are configured or activated in the first PUCCH cell group, uplink control information for the stated 20 downlink component carriers may be transmitted.

In other words, for example, the terminal device 1 may transmit HARQ-ACKs corresponding to the 20 downlink component carriers (HARQ-ACK with respect to the transmission on the PDSCH, HARQ-ACK with respect to the transport block). The terminal device 1 may transmit CSI corresponding to the 20 downlink component carriers. Further, the terminal device 1 may transmit an SR for each PUCCH cell group. Likewise, the terminal device 1 may transmit uplink control information in the second PUCCH cell group.

Further, likewise, the base station device 3 and the terminal device 1 may configure a PUCCH cell group and transmit/receive uplink control information as illustrated in FIG. 7B. Further, the base station device 3 and the terminal device 1 may configure a PUCCH cell group and transmit/receive uplink control information as illustrated in FIG. 7C.

The base station device 3 may transmit the information used for indicating a PUCCH secondary cell while making the stated information be included in the higher layer signaling and/or the PDCCH (downlink control information transmitted on the PDCCH). The terminal device 1 may determine a PUCCH secondary cell based on the information used for indicating the PUCCH secondary cell.

As discussed above, the PUCCH of the PUCCH serving cell may be used in order to transmit the uplink control information (the HARQ-ACK, CSI (periodic CSI, for example), and/or SR) for the serving cell (the PUCCH serving cell, the non-PUCCH serving cell) included in the PUCCH cell group to which the PUCCH serving cell belongs.

In other words, the uplink control information (the HARQ-ACK and/or CSI) for the serving cell (the PUCCH serving cell, the non-PUCCH serving cell) included in the PUCCH cell group is transmitted on the PUCCH of the PUCCH serving cell included in the PUCCH cell group.

The present embodiment may be applied to only the HARQ-ACK. The present embodiment may be applied to only the CSI. The present embodiment may be applied to the HARQ-ACK and the CSI. The PUCCH cell group for the HARQ-ACK and the PUCCH cell group for the CSI may be defined independently. The PUCCH cell group for the HARQ-ACK and the PUCCH cell group for the CSI may be in common.

Hereinafter, a format of the physical uplink control channel (PUCCH format) according to the present embodiment will be described.

In the PUCCH, there exist multiple PUCCH formats having different pieces of uplink control information being supported, and an appropriate PUCCH format is used in accordance with the uplink control information transmitted by the terminal device 1.

A PUCCH format 1 is used when a positive SR is transmitted, and electric power is assigned to a prescribed resource when the terminal device 1 requests scheduling to the base station device 3.

A PUCCH format 1a is used when a 1-bit HARQ-ACK with respect to a downlink signal is transmitted or when a positive SR is transmitted along with the 1-bit HARQ-ACK with respect to the downlink signal.

A PUCCH format 1b is used when a 2-bit HARQ-ACK with respect to a downlink signal is transmitted or when a positive SR is transmitted along with the 2-bit HARQ-ACK with respect to the downlink signal.

In addition, with the PUCCH format 1b, a HARQ-ACK with a maximum of four bits with respect to the downlink signal can be transmitted by being combined with channel selection in which the information indicating which resource, of multiple PUCCH resources, will be used is used as bit information.

A PUCCH format 2 is used when a CSI report in which HARQ-ACKs are not multiplexed is transmitted. However, in the case where the extended cyclic prefix is used, a CSI report in which HARQ-ACKs are multiplexed can be transmitted.

A PUCCH format 2a is used when a CSI report in which 1-bit HARQ-ACKs with respect to the downlink signal are multiplexed is transmitted.

A PUCCH format 2b is used when a CSI report in which 2-bit HARQ-ACKs with respect to the downlink signal are multiplexed is transmitted.

A PUCCH format 3 is used when a HARQ-ACK with a maximum of 10 bits is transmitted in the case of FDD or when a 1-bit positive/negative SR is transmitted along with the HARQ-ACK with the maximum of 10 bits. Further, the PUCCH format 3 is used when a HARQ-ACK with a maximum of 20 bits is transmitted in the case of TDD or when a 1-bit positive/negative SR is transmitted along with the HARQ-ACK with the maximum of 20 bits. The PUCCH format 3 is used when a CSI report for a HARQ-ACK, a 1-bit positive/negative SR, and one serving cell is transmitted.

A PUCCH format 4 is used when a HARQ-ACK with respect to a downlink signal in which carrier aggregation is performed with a maximum of 32 component carriers, a 1-bit positive/negative SR, and a CSI report are transmitted. Note that the PUCCH format 4 may be applied in the case where the number of component carriers of the downlink signal corresponding to the HARQ-ACK is greater than 5 CC. However, note that the PUCCH format 4 may be used in the case where the sum of bits of the HARQ-ACK, SR, and CSI report transmitted in a certain subframe is greater than a prescribed number of bits.

An uplink-downlink configuration (UL-DL configuration) according to the present embodiment will be described below.

The UL-DL configuration is a configuration relating to the pattern of a subframe within a radio frame. The UL-DL configuration indicates that the subframes in the radio frame each correspond to any one of the downlink subframe, the uplink subframe, and the special subframe, and is desirably expressed by any combinations of D, U, and S (which denote the downlink subframe, the uplink subframe, and the special subframe, respectively) in a length of 10. More desirably, the first subframe (to be more precise, subframe #0) is D, and the second subframe (to be more precise, subframe #1) is S.

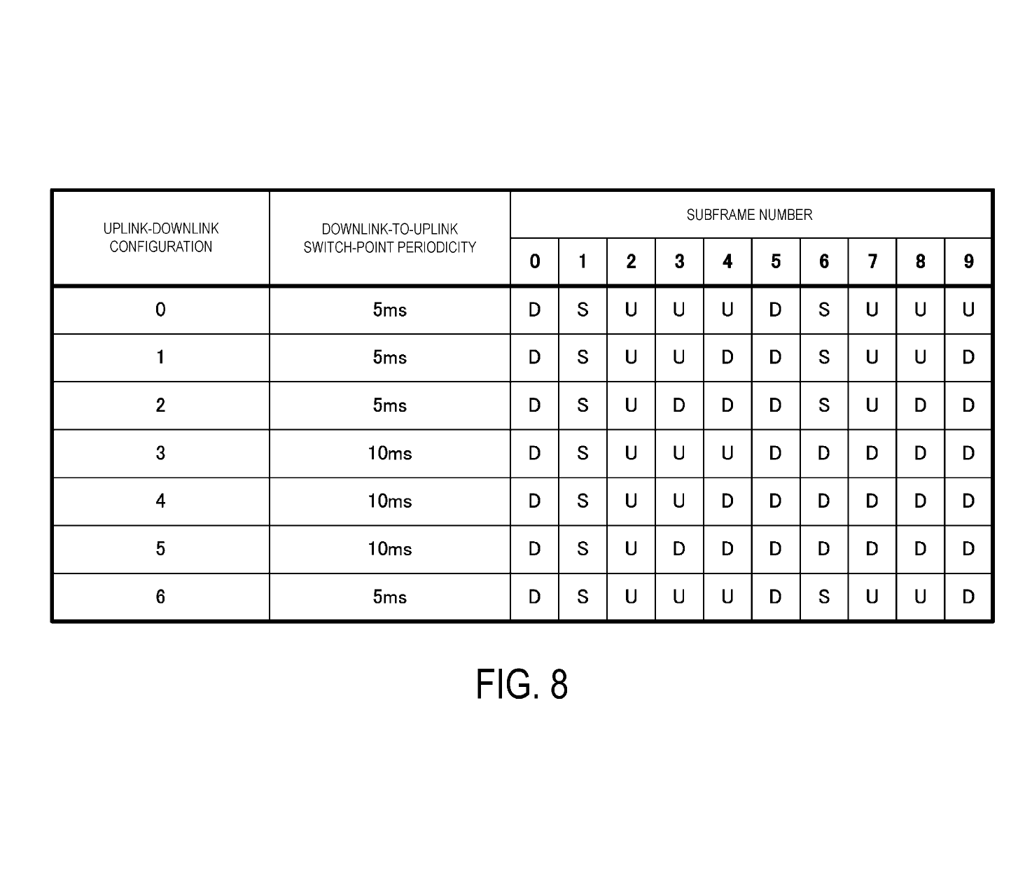

FIG. 8 illustrates one example of the UL-DL configuration according to the present embodiment. In FIG. 8, D denotes a downlink subframe, U denotes an uplink subframe, and S denotes a special subframe.

Configurations of devices according to the present embodiment will be described below.

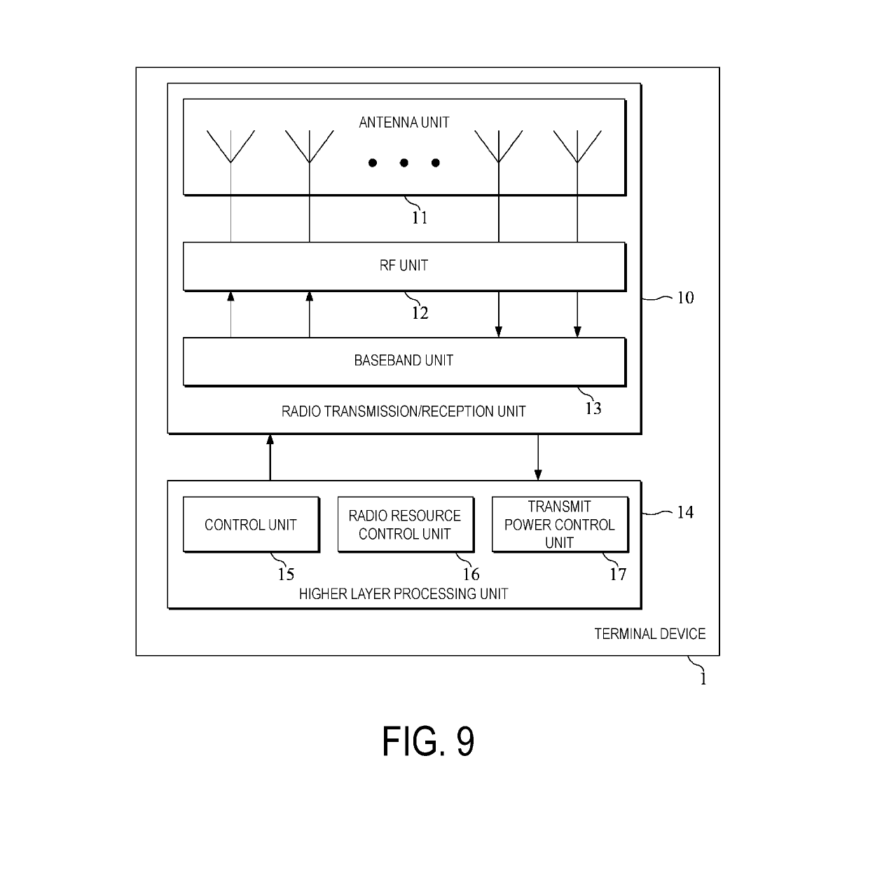

FIG. 9 is a schematic block diagram illustrating a configuration of the terminal device 1 according to the present embodiment. As illustrated in FIG. 9, the terminal device 1 is configured to include a radio transmission/reception unit 10 and a higher layer processing unit 14. The radio transmission/reception unit 10 is configured to include an antenna unit 11, a radio frequency (RF) unit 12, and a baseband unit 13. The higher layer processing unit 14 is configured to include a control unit 15, a radio resource control unit 16, and a transmit power control unit 17. The radio transmission/reception unit 10 is also referred to as a transmission unit or a reception unit.

The higher layer processing unit 14 outputs uplink data (transport block) generated by a user operation or the like, to the radio transmission/reception unit 10. The higher layer processing unit 14 performs processing of the medium access control (MAC) layer, the packet data convergence protocol (PDCP) layer, the radio link control (RLC) layer, and the radio resource control (RRC) layer.

The radio resource control unit 16 included in the higher layer processing unit 14 manages various configuration information/parameters of the terminal device 1 itself. The radio resource control unit 16 sets the various configuration information/parameters in accordance with a higher layer signaling received from the base station device 3. Specifically, the radio resource control unit 16 sets the various configuration information/parameters in accordance with the information indicating the various configuration information/parameters received from the base station device 3.

The transmit power control unit 17 included in the higher layer processing unit 14 controls the transmit power of signals (including signals of the PUSCH and PUCCH) transmitted from the radio transmission/reception unit 10. The transmit power control unit 17 determines the transmit power that is used based on the various configuration information and parameters set by the radio resource control unit 16.

The radio transmission/reception unit 10 performs processing of the physical layer, such as modulation, demodulation, coding, and decoding. The radio transmission/reception unit 10 demultiplexes, demodulates, and decodes a signal received from the base station device 3, and outputs the information resulting from the decoding to the higher layer processing unit 14. The radio transmission/reception unit 10 modulates and codes data to generate a transmit signal, and transmits the transmit signal to the base station device 3.

The RF unit 12 converts (down-converts) a signal received through the antenna unit 11 into a baseband signal by orthogonal demodulation and removes unnecessary frequency components. The RF unit 12 outputs the processed analog signal to the baseband unit.

The baseband unit 13 converts the analog signal input from the RF unit 12 into a digital signal. The baseband unit 13 removes a portion corresponding to a cyclic prefix (CP) from the converted digital signal resulting from the conversion, performs fast Fourier transform (FFT) on the signal from which the CP has been removed, and extracts a signal in the frequency domain.

The baseband unit 13 performs inverse fast Fourier transform (IFFT) on data to generate an SC-FDMA symbol, attaches a CP to the generated SC-FDMA symbol, generates a digital signal in a baseband, and converts the digital signal in the baseband into an analog signal. The baseband unit 13 outputs the analog signal resulting from the conversion, to the RF unit 12.

The RF unit 12 removes unnecessary frequency components from the analog signal input from the baseband unit 13 using a low-pass filter, up-converts the analog signal into a signal of a carrier frequency, and transmits the final result via the antenna unit 11.

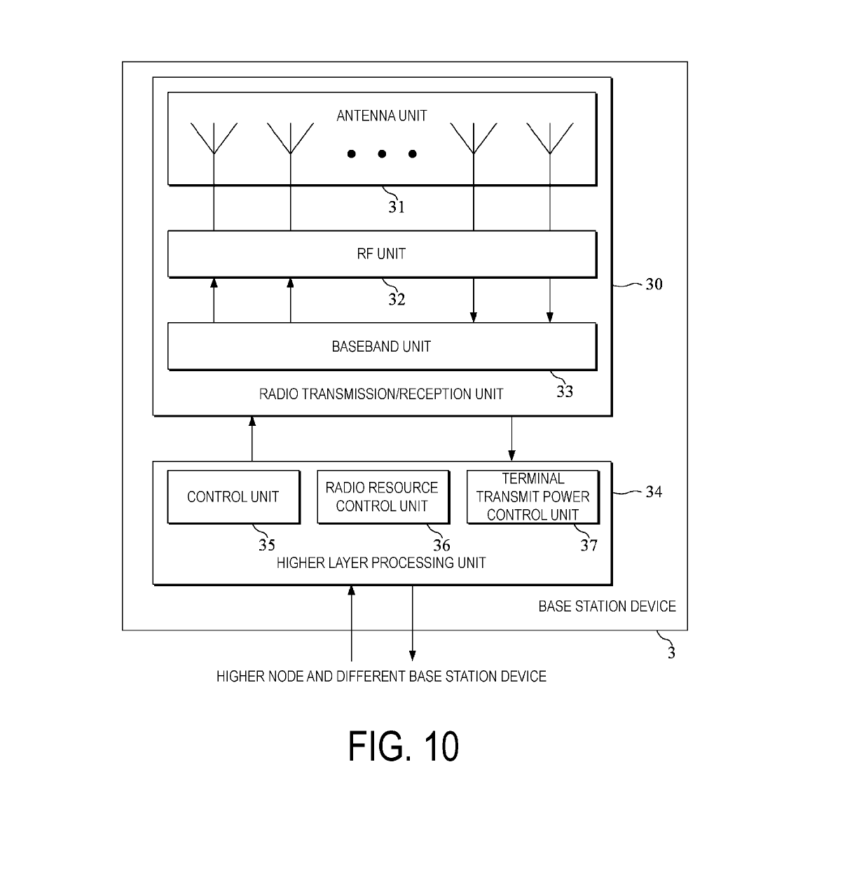

FIG. 10 is a schematic block diagram illustrating a configuration of the base station device 3 according to the present embodiment. As illustrated in FIG. 10, the base station device 3 is configured to include a radio transmission/reception unit 30 and a higher layer processing unit 34. The radio transmission/reception unit 30 is configured to include an antenna unit 31, an RF unit 32, and a baseband unit 33. The higher layer processing unit 34 is configured to include a control unit 35, a radio resource control unit 36, and a terminal transmit power control unit 37. The radio transmission/reception unit 30 is also referred to as a transmission unit or a reception unit.

The higher layer processing unit 34 performs processing of the medium access control (MAC) layer, the packet data convergence protocol (PDCP) layer, the radio link control (RLC) layer, and the radio resource control (RRC) layer.

The radio resource control unit 36 included in the higher layer processing unit 34 generates, or acquires from a higher node, downlink data (transport block) arranged on a physical downlink channel, system information, an RRC message, a MAC control element (CE), and the like, and outputs the generated or acquired data to the radio transmission/reception unit 30. Furthermore, the radio resource control unit 36 manages various pieces of configuration information/parameters for each of the terminal devices 1. The radio resource control unit 36 may set various pieces of configuration information/parameters for each of the terminal devices 1 via a higher layer signaling. In other words, the radio resource control unit 36 transmits/broadcasts information indicating various pieces of configuration information/parameters. The terminal transmit power control unit 37 configures transmit power P₀_{_}_{PUCCH}, which is base power in the transmission on the PUCCH, for the terminal device 1 communicating with the base station device 3, and transmits the above configuration to the terminal device 1 via the higher layer. Further, the terminal transmit power control unit 37 calculates a correction value of transmit power for the terminal device 1, and sets the correction value, as a TPC command, in a TPC command field for the PUCCH included in a DCI format 3 for the downlink grant or the PUCCH so as to transmit it to each of the terminal devices 1 via the radio transmission/reception unit 30.

The capability of the radio transmission/reception unit 30 is similar to that of the radio transmission/reception unit 10, and hence description thereof is omitted.

However, the capability of the radio transmission/reception unit 10 varies among the terminal devices 1. For example, combinations of bands (carriers, frequencies) to which carrier aggregation is applicable vary among the terminal devices 1. Therefore, the terminal device 1 transmits, to the base station device 3, information/parameters (UECapabilityInformation, which is also called ability information, capability information, terminal ability information, or terminal capability information) indicating the capability supported by the terminal device 1 itself.

The term “support” means that the terminal device 1 including hardware and/or software required to implement the capability (or the communication method) has passed the conformance test (standard certification test) specified in 3GPP.

Transmit power control for the transmission on the PUCCH according to the present embodiment will be described below.

In the case where a serving cell c is a PUCCH serving cell, the terminal device 1 sets, based on Equation (1), a transmit power value P_{PUCCH}(i) [dBm] for the transmission on the PUCCH in a certain subframe i of the serving cell c.

$${P}_{PUCCH} ( i ) = min \{ \begin{matrix}{P}_{CMAX , c} ( i ) , \\ {P}_{0 PUCCH} + {PL}_{c} + h ( {n}_{CQI} , {n}_{HARQ , } {n}_{SR} ) + \\ {Λ}_{F PUCCH} ( F ) + {Λ}_{TxD} ( {F}^{′} ) + g ( i )\end{matrix} \} \qquad [ Equation 1 ]$$

In the case where a PUCCH is not transmitted in a PUCCH serving cell, the terminal device 1 may assume, based on Equation (2), a transmit power value [dBm] for the transmission on the PUCCH in a certain subframe i in order to accumulate the TPC commands for the PUCCH.

P_{PUCCH}(i)=min{P_{CMAX,c}(i),P₀_{_}_{PUCCH}+PL_{c}+g(i)} [Equation 2]

In Equation (1) and Equation (2), P_{CMAX,C}(i) is a maximum transmit power configured for a subframe i in the serving cell c.

P₀_{_}_{PUCCH} is a parameter indicating the transmit power as base power for the transmission on the PUCCH, and is indicated from the higher layer. Note that a parameter P₀_{_}_{NOMINAL}_{_}_{PUCCH} common to all the terminal devices 1 connected to the base station device 3 and a parameter P₀_{_}_{UE}_{_}_{PUCCH} configured for each of the terminal devices 1 may each be indicated from the higher layer, and the P₀_{_}_{PUCCH} may be the sum of the above two parameters.

Δ_{F}_{_}_{PUCCH}(F) is an offset value indicated from the higher layer for each format of the PUCCH. For example, Δ_{F}_{_}_{PUCCH}(F) for the PUCCH format 1a is always 0.

In the case where the terminal device 1 is configured to perform PUCCH transmission using two antenna ports from the higher layer, Δ_{T×D}(F′) indicated for each format of the PUCCH is supplied from the higher layer. In other cases, Δ_{T×D}(F′) is 0.

The terminal device 1 may set a value of g(i) based on Equation (3).

$$g ( i ) = g ( i - 1 ) + {\sum }_{m = 0}^{M - 1} {δ}_{PUCCH} ( i - {k}_{m} ) \qquad [ Equation 3 ]$$

Here, δPUCCH is a correction value, and is called a TPC command.

For example, a value that is set in a field (2-bit information field) of a TPC command for the PUCCH included in the DCI format 3 for the downlink grant and the PUCCH is mapped to an accumulated correction value (−1, 0, 1, 3). For example, a value that is set in a field (1-bit information field) of a TPC command for the PUCCH included in the DCI format 3A for the PUCCH is mapped to an accumulated correction value (−1, 1).

Note that h(n_{CQI}, n_{HARQ}, n_{SR}) is a value calculated based on the number of bits transmitted on the PUCCH and the format of the PUCCH. Here, n_{CQI} represents the number of bits of channel quality information (CQI) transmitted on the PUCCH. Note that, however, the CQI may be CSI (for example, periodic CSI). n_{SR} takes a value of 1 in a subframe i in which a scheduling request (SR) is configured in a case where a transport block for the UL-SCH is not assigned in the terminal device 1; in other cases, n_{SR} takes a value of 0. n_{HARQ} represents the number of HARQ-ACK bits transmitted on the PUCCH in a subframe i.

In the PUCCH formats 1, 1a, and 1b, h(n_{CQI}, n_{HARQ}, n_{SR}) takes a value of 0.

In the PUCCH format 1b with channel selection, in a case where two or more serving cells are configured in the terminal device 1, h(n_{CQI}, n_{HARQ}, n_{SR}) equals (n_{HARQ}−1)/2; in other cases, h(n_{CQI}, n_{HARQ}, n_{SR}) equals 0.

In the PUCCH formats 2, 2a, and 2b using a normal cyclic prefix, h(n_{CQI}, n_{HARQ}, n_{SR}) is given by Equation (4).

$$h ( {n}_{CQI} , {n}_{HARQ , } {n}_{SR} ) = \{ \begin{matrix}10 {log}_{10} ( \frac{{n}_{CQI}}{4} ) & if {n}_{CQI} \geq 4 \\ 0 & otherwise\end{matrix} \qquad [ Equation 4 ]$$

In the PUCCH formats 2, 2a, and 2b using an extended cyclic prefix, h(n_{CQI}, n_{HARQ}, n_{SR}) is given by Equation (5).

$$h ( {n}_{CQI} , {n}_{HARQ , } {n}_{SR} ) = \{ \begin{matrix}10 {log}_{10} ( \frac{{n}_{CQI} + {n}_{HARQ}}{4} ) & if {n}_{CQI} + {n}_{HARQ} \geq 4 \\ 0 & otherwise\end{matrix} \qquad [ Equation 5 ]$$

In the PUCCH format 3, in the case where the terminal device 1 transmits a HARQ-ACK/SR without periodic CSI, h(n_{CQI}, n_{HARQ}, n_{SR}) is given as follows.
In a case where the terminal device 1 is configured to transmit the PUCCH format 3 using two antenna ports from the higher layer or in a case where the terminal device 1 transmits a HARQ-ACK/SR of not less than 12 bits, h(n_{CQI}, n_{HARQ}, n_{SR}) equals (n_{HARQ}+n_{SR}−1)/3; in other cases, h(n_{CQI}, n_{HARQ}, n_{SR}) equals (n_{HARQ}+n_{SR}−1)/2.

In the PUCCH format 3, in the case where the terminal device 1 transmits a HARQ-ACK/SR with periodic CSI, h(n_{CQI}, n_{HARQ}, n_{SR}) is given as follows.
In a case where the terminal device 1 is configured to transmit the PUCCH format 3 using two antenna ports from the higher layer or in a case where the terminal device 1 transmits a HARQ-ACK/SR of not less than 12 bits, h(n_{CQI}, n_{HARQ}, n_{SR}) equals (n_{HARQ}+n_{SR}+n_{CQI}−1)/3; in other cases, h(n_{CQI}, n_{HARQ}, n_{SR}) equals (n_{HARQ}+n_{SR}+n_{CQI}−1)/2.

In the PUCCH format 4, in the case where the terminal device 1 transmits a HARQ-ACK/SR without periodic CSI, h(n_{CQI}, n_{HARQ}, n_{SR}) is given as follows in accordance with the sum of n_{HARQ} and n_{SR}.
As one example, as for a relation between n_{HARQ}+n_{SR} and a previously configured threshold X_{UCI}, in a case where a relation of n_{HARQ}+n_{SR}>X_{UCI} is satisfied, h(n_{CQI}, n_{HARQ}, n_{SR}) equals h_{MAX}; in other cases, h(n_{CQI}, n_{HARQ}, n_{SR}) is configured like in the case of the PUCCH format 3. Note that X_{UCI} may be a value configured by the higher layer.
As another example, in a case where the relation of n_{HARQ}+n_{SR}>X_{UCI} is satisfied, h(n_{CQI}, n_{HARQ}, n_{SR}) equals h_{MAX}; in other cases, h(n_{CQI}, n_{HARQ}, n_{SR}) is given by (n_{HARQ}+n_{SR}−1)/A_{UCI}. Note that A_{UCI} is a predetermined value.
As another example, in a case where the relation of n_{HARQ}+n_{SR}>X_{UCI} is satisfied, h(n_{CQI}, n_{HARQ}, n_{SR}) equals h_{MAX}; in other cases, h(n_{CQI}, n_{HARQ}, n_{SR}) is given by Equation (6).

$$h ( {n}_{CQI} , {n}_{HARQ , } {n}_{SR} ) = \{ \begin{matrix}10 {log}_{10} ( \frac{{n}_{HARQ} + {n}_{SR}}{{B}_{UCI}} ) & if {n}_{HARQ} + {n}_{SR} \geq {B}_{UCI} \\ 0 & otherwise\end{matrix} \qquad [ Equation 6 ]$$

Note that B_{UCI} is a predetermined value.

In the PUCCH format 4, in the case where the terminal device 1 transmits a HARQ-ACK/SR with periodic CSI, h(n_{CQI}, n_{HARQ}, n_{SR}) is given as follows, in accordance with the sum of n_{CQI}, n_{HARQ}, and n_{SR}.
As one example, as for a relation between n_{CQI}+n_{HARQ}+n_{SR} and the previously configured threshold X_{UCI}, in a case where a relation of n_{CQI}+n_{HARQ}+n_{SR}>X_{UCI} is satisfied, h(n_{CQI}, n_{HARQ}, n_{SR}) equals h_{MAX}; in other cases, h(n_{CQI}, n_{HARQ}, n_{SR}) is configured like in the case of the PUCCH format 3. Note that X_{UCI} may be a value configured by the higher layer.
As another example, in a case where the relation of n_{CQI}+n_{HARQ}+n_{SR}>X_{UCI} is satisfied, h(n_{CQI}, n_{HARQ}, n_{SR}) equals h_{MAX}; in other cases, h(n_{CQI}, n_{HARQ}, n_{SR}) is given by (n_{CQI}+n_{HARQ}+n_{SR}−1)/A_{UCI}. Note that A_{UCI} is a predetermined value.
As another example, in a case where the relation of n_{CQI}+n_{HARQ}+n_{SR}>X_{UCI} is satisfied, h(H_{CQI}, n_{HARQ}, n_{SR}) equals h_{MAX}; in other cases, h(H_{CQI}, n_{HARQ}, n_{SR}) is given by Equation (7).

$$h ( {n}_{CQI} , {n}_{HARQ , } {n}_{SR} ) = \{ \begin{matrix}10 {log}_{10} ( \frac{{n}_{CQI} + {n}_{HARQ} + {n}_{SR}}{{B}_{UCI}} ) \\ 0\end{matrix} \begin{matrix}\begin{matrix}if {n}_{CQI} + {n}_{HARQ} + \\ {n}_{SR} \geq {B}_{UCI}\end{matrix} \\ otherwise\end{matrix} \qquad [ Equation 7 ]$$

Note that B_{UCI} is a predetermined value.

In the PUCCH format 4, h(n_{CQI}, n_{HARQ}, n_{SR}) may use a value configured by the higher layer.

In the PUCCH format 4, h(n_{CQI}, n_{HARQ}, n_{SR}) may switch and use one of the above-described examples following the indication from the higher layer.

In consideration of a transmit power control method for the above-mentioned terminal, the terminal transmit power control unit 37 of the base station device 3 may perform transmit power control on the terminal. For example, in the case where the base station device 3 transmits a signal to the terminal device 1 using more than five downlink serving cells, the terminal transmit power control unit 37 may configure the P₀_{_}_{PUCCH} (or P₀_{_}_{UE}_{_}_{PUCCH}) assuming that the PUCCH format 4 is used. In the case where the base station device 3 transmits a signal to the terminal device 1 using more than five downlink serving cells, the terminal transmit power control unit 37 may configure the TPC command assuming that the PUCCH format 4 is used.

As discussed thus far, the terminal device 1 according to the present embodiment may have the following features.

The terminal device 1 according to the present embodiment is the terminal device 1 that communicates with the base station device 3 and is provided with: the radio transmission/reception unit 10 (it may also be called a transmission unit) configured to transmit, via a physical uplink control channel (PUCCH), uplink control information (also called uplink control information (UCI) in some case) including at least one of a HARQ-ACK, CSI, and a scheduling request (SR) using one of multiple formats (called PUCCH formats); and the higher layer processing unit 14 configured to control transmit power for the transmission of the PUCCH. The stated transmit power is based on a parameter h(n_{CQI}, n_{HARQ}, n_{SR}) calculated from the number of bits of the UCI to be transmitted (including at least one of n_{CQI}, n_{HARQ}, and n_{SR}), and the above parameter h(n_{CQI}, n_{HARQ}, n_{SR}) has a constant value (h_{MAX}) for at least one of the multiple PUCCH formats (for example, the PUCCH format 4) in the case where the above number of bits is greater than a prescribed value (X_{UCI}).

Further, in the terminal device 1 according to the present embodiment, the above-mentioned constant value (h_{MAX}) may be a value configured by the base station device 3 via the higher layer.

The base station device 3 according to the present embodiment may have the following features.

The base station device 3 according to the present embodiment is the base station device 3 that communicates with the terminal device 1 and is provided with: the radio transmission/reception unit 30 (it may also be called a reception unit) configured to receive, from the terminal device 1 through a physical uplink control channel (PUCCH), uplink control information (UCI in some case) including at least one of a HARQ-ACK, CSI, and a scheduling request (SR) using one of multiple formats; the higher layer processing unit 34 configured to determine a first parameter (for example, P₀_{_}_{PUCCH} or P₀_{_}_{UE}_{_}_{PUCCH}) to control transmit power of the terminal device 1 for the transmission of the PUCCH; and a transmission unit (it may be the same as the radio transmission/reception unit 30) configured to transmit the first parameter to the terminal device. The higher layer processing unit 34 determines the first parameter while taking into consideration that the terminal device 1 determines the above transmit power based on a second parameter (h(n_{CQI}, n_{HARQ}, n_{SR})) calculated from the number of bits of the UCI to be transmitted, and the second parameter has a constant value (h_{MAX}) for at least one of the multiple PUCCH formats in the case where the number of bits is greater than a prescribed value (X_{UCI}).

Further, the base station device 3 according to the present embodiment may transmit the above constant value to the terminal device via the higher layer.

A program running on each of the base station device 3 and the terminal device 1 according to the present invention may be a program that controls a central processing unit (CPU) and the like (a program for causing a computer to operate) in such a manner as to realize the functions according to the above-described embodiments of the present invention. The information handled in these devices is temporarily stored in a random access memory (RAM) while being processed. Thereafter, the information is stored in various types of read only memory (ROM) such as a flash ROM and a hard disk drive (HDD) and when necessary, is read by the CPU to be modified or rewritten.

Moreover, the terminal device 1 and the base station device 3 according to the above-described embodiments may be partially realized by the computer. This configuration may be realized by recording a program for realizing such control functions on a computer-readable medium and causing a computer system to read the program recorded on the recording medium for execution.

The “computer system” refers to a computer system built into the terminal device 1 or the base station device 3, and the computer system includes an OS and hardware components such as a peripheral device. Furthermore, the “computer-readable recording medium” refers to a portable medium such as a flexible disk, a magneto-optical disk, a ROM, and a CD-ROM, and a storage device such as a hard disk built into the computer system.

Moreover, the “computer-readable recording medium” may include a medium that dynamically retains the program for a short period of time, such as a communication line that is used to transmit the program over a network such as the Internet or over a communication circuit such as a telephone circuit, and a medium that retains, in that case, the program for a fixed period of time, such as a volatile memory within the computer system which functions as a server or a client. Furthermore, the program may be configured to realize some of the functions described above, and additionally may be configured to realize the functions described above in combination with a program already recorded in the computer system.

Furthermore, the base station device 3 according to the above-described embodiments can be realized as an aggregation (a device group) constituted of multiple devices. Devices constituting the device group may be each equipped with some or all portions of each function or each functional block of the base station device 3 according to the above-described embodiments. It is only required that the device group itself include general functions or general functional blocks of the base station device 3. Furthermore, the terminal device 1 according to the above-described embodiments can communicate with the base station device as the aggregation.

Furthermore, the base station device 3 according to the above-described embodiments may be an Evolved Universal Terrestrial Radio Access Network (EUTRAN). Furthermore, the base station device 3 according to the above-described embodiments may have some or all portions of the function of a node higher than an eNodeB.

Furthermore, some or all portions of each of the terminal device 1 and the base station device 3 according to the above-described embodiments may be realized as an LSI that is a typical integrated circuit or may be realized as a chip set. The functional blocks of each of the terminal device 1 and the base station device 3 may be individually realized as a chip, or some or all of the functional blocks may be integrated into a chip. Furthermore, the circuit integration technique is not limited to the LSI, and the integrated circuit may be realized with a dedicated circuit or a general-purpose processor. Furthermore, if with advances in semiconductor technology, a circuit integration technology with which an LSI is replaced appears, it is also possible to use an integrated circuit based on the technology.

Furthermore, according to the above-described embodiments, the terminal device is described as one example of a communication device, but the present invention is not limited to this, and can be applied to a fixed-type electronic apparatus installed indoors or outdoors, or a stationary-type electronic apparatus, for example, a terminal device or a communication device, such as an audio-video (AV) apparatus, a kitchen apparatus, a cleaning or washing machine, an air-conditioning apparatus, office equipment, a vending machine, and other household apparatuses.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible within the scope of the appended claims, and embodiments that are made by suitably combining technical means disclosed according to the different embodiments are also included in the technical scope of the present invention. Furthermore, a configuration in which a constituent element that achieves the same effect is substituted for the one that is described according to the embodiments is also included in the technical scope of the present invention.

### INDUSTRIAL APPLICABILITY

The present invention can be applied to at least mobile phones, personal computers, tablet-type computers, and the like.

### REFERENCE SIGNS LIST

1 (1A, 1B, 1C) Terminal device
3 Base station device
10 Radio transmission/reception unit
11 Antenna unit
12 RF unit
13 Baseband unit
14 Higher layer processing unit
15 Control unit
16 Radio resource control unit
17 Transmit power control unit
30 Radio transmission/reception unit
31 Antenna unit
32 RF unit
33 Baseband unit
34 Higher layer processing unit
35 Control unit
36 Radio resource control unit
37 Terminal transmit power control unit

1. A terminal device configured to communicate with a base station device, comprising:
a transmission unit configured to transmit, through a physical uplink control channel, uplink control information including at least one of a HARQ-ACK, CSI, and a scheduling request (SR) using one of multiple formats; and
a higher layer processing unit configured to control transmit power for transmission of the physical uplink control channel;
the transmit power being based on a parameter calculated from a number of bits of the uplink control information to be transmitted; and
the parameter having a constant value for at least one of the multiple formats in a case where the number of bits is greater than a prescribed value.

2. The terminal device according to claim 1, wherein
the constant value is a value configured by the base station device via a higher layer.

3. A base station device configured to communicate with a terminal device, comprising:
a reception unit configured to receive, from the terminal device through a physical uplink control channel, uplink control information including at least one of a HARQ-ACK, CSI, and a scheduling request (SR) using one of multiple formats;
a higher layer processing unit configured to determine a first parameter to control transmit power of the terminal device for transmission of the physical uplink control channel; and
a transmission unit configured to transmit the first parameter to the terminal device;
the higher layer processing unit determining the first parameter while taking into consideration that the terminal device determines the transmit power based on a second parameter calculated from a number of bits of the uplink control information to be transmitted; and
the second parameter having a constant value for at least one of the multiple formats in a case where the number of bits is greater than a prescribed value.

4. The base station device according to claim 3, wherein
the base station device transmits the constant value to the terminal device via a higher layer.

5. An integrated circuit that is mounted in a terminal device communicating with a base station device, the integrated circuit causing the terminal device to exhibit a series of functions including:
a function to transmit, through a physical uplink control channel, uplink control information including at least one of a HARQ-ACK, CSI, and a scheduling request (SR) using one of multiple formats; and
a function to control transmit power for transmission of the physical uplink control channel;
the transmit power being based on a parameter calculated from a number of bits of the uplink control information to be transmitted; and
the parameter having a constant value for at least one of the multiple formats in a case where the number of bits is greater than a prescribed value.

6. The integrated circuit according to claim 5, wherein the constant value is a value configured by the base station device via a higher layer.

7. An integrated circuit that is mounted in a base station device communicating with a terminal device, the integrated circuit causing the base station device to exhibit a series of functions including:
a function to receive, from the terminal device through a physical uplink control channel, uplink control information including at least one of a HARQ-ACK, CSI, and a scheduling request (SR) using one of multiple formats;
a function to determine a first parameter to control transmit power of the terminal device for transmission of the physical uplink control channel; and
a function to transmit the first parameter to the terminal device;
the first parameter being determined while taking into consideration that the terminal device determines the transmit power based on a second parameter calculated from a number of bits of the uplink control information to be transmitted; and
the second parameter having a constant value for at least one of the multiple formats in a case where the number of bits is greater than a prescribed value.

8. The integrated circuit according to claim 7, wherein
the integrated circuit causes the base station device to perform a function to transmit the constant value to the terminal device via a higher layer.

9. A communication method that is used in a terminal device communicating with a base station device, the method comprising the steps of:
transmitting, through a physical uplink control channel, uplink control information including at least one of a HARQ-ACK, CSI, and a scheduling request (SR) using one of multiple formats; and
controlling transmit power for transmission of the physical uplink control channel;
the transmit power being based on a parameter calculated from a number of bits of the uplink control information to be transmitted; and
the parameter having a constant value for at least one of the multiple formats in a case where the number of bits is greater than a prescribed value.

10. The communication method according to claim 9, wherein
the constant value is a value configured by the base station device via a higher layer.

11. A communication method that is used in a base station device communicating with a terminal device, the method comprising the steps of:
receiving, from the terminal device through a physical uplink control channel, uplink control information including at least one of a HARQ-ACK, CSI, and a scheduling request (SR) using one of multiple formats;
determining a first parameter to control transmit power of the terminal device for transmission of the physical uplink control channel; and
transmitting the first parameter to the terminal device;
the first parameter being determined while taking into consideration that the terminal device determines the transmit power based on a second parameter calculated from a number of bits of the uplink control information to be transmitted; and
the second parameter having a constant value for at least one of the multiple formats in a case where the number of bits is greater than a prescribed value.

12. The communication method according to claim 11, wherein
the constant value is transmitted to the terminal device via a higher layer.
